(19) United States
(12) Patent Application Publication
(10) Pub. No.: US 2012/0229509 A1
(43) Pub. Date: Sep. 13, 2012

(54) SYSTEM AND METHOD FOR USER INTERACTION

(76) Inventor: Guangsong LIU, Beijing (CN)

(21) Appl. No.: 13/291,750

(22) Filed: Nov. 8, 2011

Related U.S. Application Data
(63) Continuation-in-part of application No. PCT/CN2011/077993, filed on Aug. 4, 2011.

(30) Foreign Application Priority Data
Mar. 7, 2011 (CN) 201110053702.2

(51) Int. Cl. G09G 5/00; G06F 3/033

(52) U.S. Cl. 345/633; 345/156; 345/157

(57) ABSTRACT

A system is used for user interaction. When the system is in use, a signal source is configured to provide an image signal to a retina display unit. The retina display unit is configured to project the image signal provided by the signal source onto a user's retina such that the user visually senses a virtual interface. The image signal is displayed on the virtual interface. A camera unit is configured to capture the user's body motion. An identification-interaction unit is configured to determine an interactive operation command corresponding to the user's body motion and transmit the interactive operation command to the signal source.

### FIELD OF THE INVENTION

This invention relates to the electronic application technical field and more particularly, a system and a method for user interaction.

### BACKGROUND OF THE INVENTION

With the development of society and the coming era of information explosion, people increasingly rely on all kinds of consumer electronics, such as a mobile termination, PDA, etc., to acquire various information. For example, a person can communicate with others through phone, browse a web page to obtain news, and check e-mail, etc.

Nowadays, people mainly use an input/output device such as a traditional keyboard or an emerging touch screen to achieve interaction with these devices. Firstly, the operation based on button-pressing is not in conformity with human body natural behavior. Furthermore, though the lately emerging touching screen facilitates the input operation of people and improves the user experience to a certain extent, it limits user's hand to the physically presented 2D screen plane for operation, which is not in conformity with the most natural operating habits of human.

During the current interaction process, the information that people concerns is all represented on the physically presented screen or keyboard, or it is necessary to use these physically presented screen or keyboard to send command to the devices. However, whether a screen or a keyboard is a hardware entity, which thus would necessarily be restricted by its physical dimension and need to occupy a certain physical space, and the screen is easily to be affected by the ambient light and the control is not convenient, thus limiting the user experience greatly.

### SUMMARY OF THE INVENTION

Accordingly, an embodiment of the present invention provides a system for user interaction to improve the user experience.

Also, an embodiment of the present invention provides a method for user interaction to improve the user experience.

The technical solutions of the present invention are provided as follows:

A system for user interaction, comprising a signal source, a retina display unit, a camera unit and an identification-interaction unit, wherein

the signal source is configured to provide an image signal to the retina display unit;

the retina display unit is configured to project the image signal provided by the signal source onto the user's retina such that the user visually senses a virtual interface, and said image signal is displayed on said virtual interface;

the camera unit is configured to capture the user's body motion;

the identification-interaction unit is configured to determine an interactive operation command corresponding to the user's body motion and transmit said interactive operation command to the signal source.

A method for user interaction, including:

by a signal source, providing an image signal to a retina display unit;

by the retina display unit, projecting the image signal provided by the signal source onto the user's retina such that the user visually senses a virtual interface, and the image signal being displayed on the virtual interface;

by a camera unit, capturing the user's body motion;

by an identification-interaction unit, determining an interactive operation command corresponding to the user's body motion and transmitting the interactive operation command to the signal source.

As can be seen from the above technical solution, in embodiments of the present invention, an inventive system and an inventive method for user interaction are provided. In an embodiment of the present invention, a signal source provides an image signal to a retina display unit; the retina display unit projects the image signal provided by the signal source onto the user's retina such that the user visually senses a virtual interface, and the image signal is displayed on the virtual interface; a camera unit captures the user's body motion(s);

an identification-interaction unit determines interactive operation command(s) corresponding to the user's body motion(s), and transmits the interactive operation command(s) to the signal source. As can be seen, with the embodiment of the present invention, the physically presented keyboard and touching screen are not needed, and a manner of the interaction and information acquisition between the user and a hardware device is achieved by means of a virtual interface, thus improving the user experience greatly.

Furthermore, this manner of interaction as embodied in the present invention is very natural, in conformity with the interaction mode of human's basic body motions (such as gestures) and with a reduced study cost for users to operate devices. Moreover, the embodiments of the present invention are in conformity with the natural interaction, operation and control with the human body as well as the separation design of hardware device for processing portable information, thus a person can pay more attention to the information he/she concerns rather than the hardware device itself.

In addition, the unique display manner of the embodiments of the present invention makes itself to be less affected by environment, provides a person with a high-quality sensory experience and can protect the information privacy. With the embodiments of the present invention, by mans of a manner of direct retina scanning projection display, virtual information can be integrated with a real scene to provide the user with an augment reality sensory experience, based on which there can generate a lot of practical applications to improve the user experience greatly.

Moreover, the embodiments of the present invention can be applied to any device for human-machine information interaction, and have a generality to facilitate people greatly.

### BRIEF DESCRIPTION OF THE DRAWINGS

FIG. 1 is a schematic diagram illustrating the structure of a system for user interaction according to an embodiment of the present invention;

FIG. 2 is a schematic diagram illustrating the flowchart of a method for user interaction according to an embodiment of the present invention;

FIG. 3 is a schematic diagram illustrating the gesture touch-controlling interaction according to an embodiment of the present invention;

FIG. 4 is a schematic diagram illustrating superimposition of the virtual interface and the real environment according to an embodiment of the present invention;

FIG. 5 is a schematic diagram illustrating the operation of a spatial virtual pointer element according to an embodiment of the present invention.

### EMBODIMENTS OF THE INVENTION

In order to better illustrate the purposes, the technical solutions and the advantages of the embodiments of the present invention, the embodiments of the present invention will be described in more details hereinafter in combination with the drawings and the specific embodiments.

In an embodiment of the present invention, for the defect that various electronic devices (such as portable electronic devices) in the prior art employing physical screens or keyboards or the like as interaction means will affect the user experience, a method of direct retina display is provided, making the user sense a virtual screen interface present in the front by a certain distance, wherein the key information can be displayed in a highlight way on the virtual screen interface, and interaction can be achieved by identifying the user's body motion with respect to the virtual interface.

An embodiment of the present invention employs a method of direct retina scanning projection to generate a virtual screen interface, avoiding various problems due to employing physical keyboards or physical screens, and not affecting background viewing field, and the virtual screen interface generated by it can be used for the augment of real scene, which can be widely used for augment reality technology.

Besides, for the above-described virtual interface, an embodiment of the present invention provides an human-oriented interaction solution based on identification of human's body motion (human's gestures preferred), and this interaction solution can smoothly incorporate the above-mentioned virtual interface and the controlling information of human's body motion. By optimizing some basic and typical operation identification processes, a stable interaction development platform is formed, for developers to develop various applications.

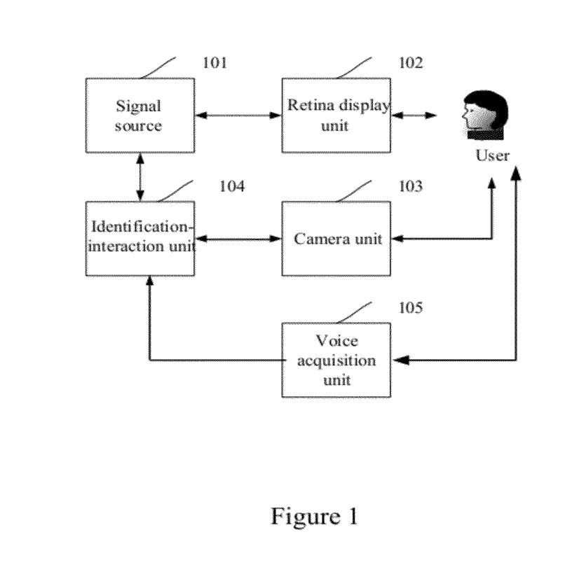

FIG. 1 is a schematic diagram illustrating the structure of a system for user interaction according to an embodiment of the present invention.

Referring to FIG. 1, the system includes: a signal source 101, a retina display unit 102, a camera unit 103 and an identification-interaction unit 104, wherein: the signal source 101 is configured to provide an image signal to retina display unit 102; the retina display unit 102 is configured to project the image signal provided by signal source 101 onto the user's retina such that the user visually senses a virtual interface, and said image signal is displayed on said virtual interface; the camera unit 103 is configured to capture the user's body motion; the identification-interaction unit 104 is configured to determine the interactive operation command corresponding to the user's body motion and transmit said interactive operation commander to the signal source 101.

For the above embodiment, the signal source 101 may be any device which can provide the image signal. The signal source 101 may be the one from any device of information acquisition, such as a mobile terminal, a computer or an information service platform based on cloud computing and so on.

The signal source 101 may process the relevant interaction processing command through its built-in operation system to achieve some kind of operation (such as mobile dialing, web browsing, etc.), and updates the relevant image signal in real time via a wired or wireless way, and output the image signal to the retina display unit 102.

Preferably, the communication way between the signal source 101 and the retina display unit 102 may take various specific forms of embodiments, including but not limited to: wireless broadband transmission, Bluetooth transmission, infrared transmission, mobile communication transmission, or wired transmission, and the like.

The retina display unit 102 receives the image signal from the wireless signal source 101 via the above-mentioned communication way.

The retina display unit 102 can generate this virtual interface by various ways. Preferably, the retina display unit 102 can generate the virtual interface by a way of direct retina projection. For example, in an embodiment, the retina display unit 102 can be embodied as a direct retina projection apparatus. In this embodiment, by means of the principle of persistence of vision, a display chip in the retina display unit 102 (i.e. the direct retina projection apparatus) receives the image signal from the signal source 101, and then modulates red, green and blue laser generated by a micro laser generator in the retina display unit 102, thus forming a low-power laser fast scanning periodically on both horizontal and vertical directions in the designated order to strike a small region of the retina to make it have light sensation, such that the people sense the presence of virtual image. This kind of display way can have no affection on the background viewing field existing in reality, and the virtual screen superimposes onto the real viewing field to thus provide a sensory experience of augment reality.

In an embodiment, one virtual interface displays the image signal corresponding to one image. Optionally, one virtual interface may also display the image signal(s) corresponding to multiple images.

In another embodiment, the light emitting from the micro laser generator in the retina display unit 102, after being modulated by the image signal from the signal source 101, will carry specific image information, and then the light carrying the specific image information will pass through a light path in the retina display unit 102 and be projected directly onto the user eyes' retinas. The light carrying the specific image information together with the environmental light around the user will enter the user's eyes, and thus a virtual interface formed by the light carrying the specific image information and generated by the retina display unit 102 will be added into the user's viewing field. Preferably, this virtual interface can, in translucent form, be superimposed on the real environment viewing field formed by the real environmental light around the user. Thus, any information which the user is interested in can be represented by this virtual interface, and such information can be used as augment to real scene.

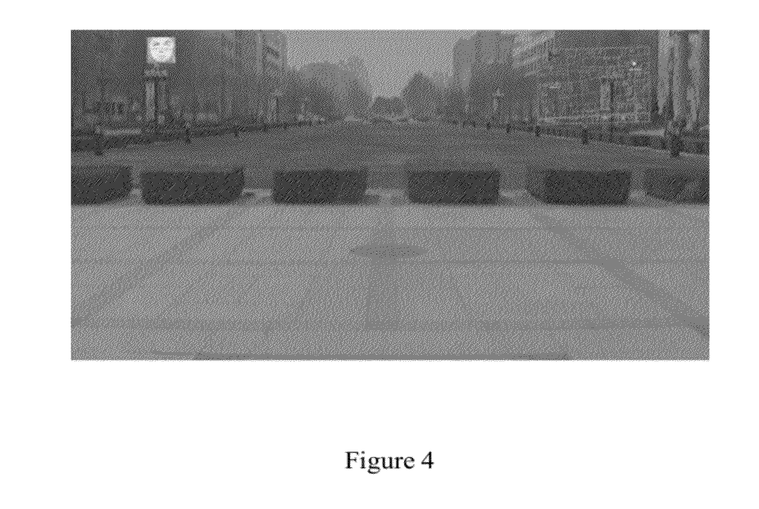

FIG. 4 is a schematic diagram illustrating superimposition of the virtual interface and the real environment, as seen from the user, according to an embodiment of the present invention. Referring to FIG. 4, on the top-left corner of people's visual field, a virtual interface of the image of Michael Jackson is presented, and this virtual interface is superimposed in a translucent form on the real environment viewing field formed by the real environment light around the user, thereby achieving the augment to the real scene. What is more, on the top-right corner of people's visual field, an virtual interface of a small map is presented which small map includes the navigation information of the destination for the user, Besides, in the right-front of people's visual field, a virtual interface of a virtual arrow laid on the road is presented, and such virtual arrow indicates a direction in which the user now should travel.

When the virtual interface appears, the user can trigger the interaction process by various body motions (for example, gestures preferred). The camera unit is configured to capture user's body motions. In particular, the camera unit 103 captures user's body motion by taking the scene in the viewing field in real time, and transmits the captured image data including the information of scene depth to the identification-interaction unit 104. Then, the identification-interaction unit 104 can, by means of a series of software algorithms, obtain by analysis a trajectory of the user's body motion (gestures preferred) and thus obtain by analysis the intention of user's interaction command.

In a preferred embodiment, the signal source 101 is further used for providing the image signal, corresponding to that after execution of the interactive operation command, to the retina display unit 102 in real time.

Specifically, according to the real-time image data in the viewing field provided by the camera unit 103, the identification-interaction unit 104 determines and obtains by analysis the interactive operation intention represented by the user's body motion, and transforms this interaction intention into the interactive operation command and transmit it to the signal source 101.

For example, if the user's hand waves from right to left across the viewing field region of the camera unit 103, the camera unit 103 will record the image data in real time and transmit the image data to the identification-interaction unit 104. With the analysis to the image data by means of a series of software algorithms, the identification-interaction unit 104 obtains that the user's hand trajectory is waving from right to left, then, by means of the software algorithm, determines that it corresponds to a certain interaction command (e.g. back to the previous page), and transmits the data stream of this interaction command to the signal source 101. The signal source 101 processes the data stream of this command and gives a feedback.

In the real interaction process, the identification-interaction unit 104 can identify a series of interaction commands. For example, the gestures, such as “start interacting/confirm/choose/click”, “move (up, down, left, right, forward, back)”, “zoom in”, “zoom out”, “rotate”, “exit/end interacting”, and the like, are transformed into interactive operation commands in real time which are transmitted to the signal source 101, and after receiving the interaction command, the signal source 101 will make corresponding execution for processing, and thus further control the retina display unit 102 to output the relevant display status after interaction.

Hereinafter, a complete exemplary interaction process is illustrated to better explain the embodiments of the present invention.

It is assumed that the user's hand waves from right to left across the viewing field region of the camera unit 103, and the body motion of “the user's hand waves from right to left” is pre-set to correspond to the interactive operation command of “back to the previous page” (The corresponding relation between the body motion and the interactive operation command could be pre-stored in the identification-interaction unit 104).

First, the camera unit 103 records image data in real time and transmits the image data to the identification-interaction unit 104. With the analysis to the image data by means of a series of software algorithms, the identification-interaction unit 104 obtains that the user's hand trajectory is waving from right to left, then, by means of the software algorithm, determines that this gesture corresponds to the command of “back to the previous page”, and transmits the data stream of this interaction command to the signal source 101. After receiving the interaction command, the signal source 101 executes the command “back to the previous page”, and thus further controls the retina display unit 102 to output the display status after execution of the command of “back to the previous page”.

Preferably, the identification-interaction unit 104 has the ability of self-learning and a certain user-defined extended operation function, thus the user can, according to his/her own gestures habits, train the system to improve its ability to identify gestures, and also can, according to his/her own favors, self-define various operation gestures and operation modes.

In the user identification-interaction software, many parameters are pre-set, such as the information of human's skin color, information of an arm's length, and so on. Under the initial condition, these parameters have initial values based on statistic average to best satisfy most of the users. The system can achieve the self-learning ability by means of software algorithm. That is, with more and more use by the user, the software can, according to his/her own features, modify some of the parameters to make the identification-interaction be more adaptive to the features of the specific user, thus improving the system's ability of gesture identification.

Besides, the user identification-interaction software could also provide a user-defined operation interface, for example, a specific gesture's trajectory favored by the user represents a certain user-defined operation command, thus achieving personalized and customized features of the system.

More specifically, the user's interactive operation to the virtual interface includes two types: one is to identify a non-precise positioning operation, for such commands as “page turning”, “going forward”, “going back”, and so on, the other is to achieve a precise positioning operation, such as operations of clicking a button in the virtual interface or choosing a specific region and the like.

For the identification of non-precise positioning operation, it only needs to record and analyze the information of the hand's moving trajectory. For example, the non-precise positioning operation may include: hand waving from right to left, hand waving from left to right, hand waving from up to down, hand waving from down to up, and separating of hands, converging of hands, etc.

To achieve the identification of precise operation, it needs to track the moving trajectory of user's hand in real time and correspond to the pointer element on the virtual interface so as to determine the position of the element(s) to be precisely interacted by the user on the virtual interface. The interaction identification unit 104 analyzes and determines the intention of the user's hand trajectory to obtain the interaction command, thus achieving the precise operation to the interface.

In a preferred example of the embodiment of the present invention, the system further includes a voice acquisition unit 105. The voice acquisition unit 105 is configured to acquire the user's voice interactive command and transmit it to the identification-interaction unit 104. The identification-interaction unit 104 is configured to identify the user's interactive intention command by a voice identification process to the user's voice interactive command. The signal source 101 is configured to provide the retina display unit 102 in real time with the image signal corresponding to that after execution of the identified user's interactive intention command, based on the user's interactive intention command identified by the identification-interaction unit 104.

Specifically, the voice acquisition unit 105 acquires user's voice interactive command, and transmits the user's voice interactive command to the identification-interaction unit 104. The identification-interaction unit 104 obtains the user's interactive intention command by a voice analysis process to the user's voice interactive command, and transmits the user's interactive intention command to the signal source 101. The signal source 101 processes the interactive intention based on the interactive intention command, and updates the information in real time to control the retina display unit 102 to feed back to the user.

For example, in an exemplary application where a user inputs text through voice, in case of a certain application where the user needs to edit text (such as editing a SMS (Short Messaging Service) message), when the user wants to express “know” and reads out the “know” with its Chinese pronunciation of “zhidao”, the voice signal is acquired by the voice acquisition unit 105 and transmitted to the identification-interaction unit 104. The identification-interaction unit 104, by means of a series of prior voice identification algorithms, calculates an interactive identification result, and transmits the interactive identification result to the signal source 101. The signal source 101 receives the interactive identification result, and controls the retina display unit 102 to control the feedback information to be output on the virtual interface. For example, the retina display unit 102 provides the user with the virtual interface wherein several optional words which have the same Chinese pronunciation as “zhidao”, such as “know”, “guide”, “until”, “principle”, “direct”, are displayed, the user may use hand to control a corresponding pointer on the virtual interface to move to the optional word of “know” and click it to make a choice, thus finish the input of the word of “know”.

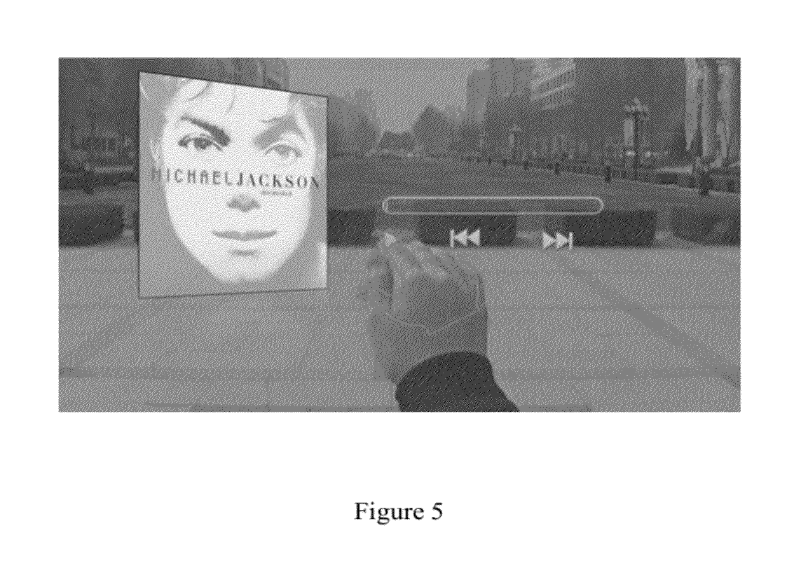

FIG. 5 is a schematic diagram illustrating the operation of a spatial virtual pointer element according to an embodiment of the present invention. As shown in FIG. 5, when the user's hand enters the detection range of the camera unit 103, the camera unit 103 determines it as human's hand, and the retina display unit 102 displays, on the virtual interface, the spatial virtual pointer element(s) (i.e. the virtual hand in FIG. 5) corresponding to the user's hand. When the hand moves in the detection range of the camera unit 103, the camera unit 103 captures the user's hand motion(s), generates image data corresponding to the user's hand motion(s), and transmits the image data to the identification-interaction unit 104. The identification-interaction unit 104, according to the image data, tracks the information of the user's hand position and shape in real time, and sends the computation result as feedback to the signal source 101. The signal source 101, according the information of user's hand position and shape provided by the identification-interaction unit 104, updates in real time the position and shape of the virtual pointer (i.e. the virtual hand in FIG. 5) in the virtual interface, and outputs the image signal of the virtual pointer to the retina display unit 102 in real time, thus achieving that the moving trajectory of the virtual pointer on the virtual interface is in conformity with the user's hand motion. The user positions the virtual pointer on the location(s) of the interactive element(s) in the virtual interface by moving hand(s), and makes interactive motion(s) (such as clicking operation, as shown in the following figure(s)), thus achieving a precise interactive operation on the interactive elements in the virtual interface.

In a preferable example of the embodiment of the present invention, the virtual pointer could be a transparent profile line typed pointer superimposed on the user's hand in real time, and preferably in a hand shape. Firstly, such hand-type transparent profile line typed pointer superimposed on the user's hand is relatively vivid. Secondly, during use of the user, such transparent profile line typed pointer has less interference with the user's visual field.

In a particular embodiment, the retina display unit 102, the camera unit 103 and the identification-interaction unit 104 can be physically integrated into a whole. Optionally, the identification-interaction unit 104 and the signal source 101 can be physically integrated into a whole, and the retina display unit 102 and the camera unit 103 can be physically integrated into a whole.

Hereinafter, the whole running process of the system will be explained in details by a flow process of a specific example of looking over an E-book.

First, the signal source 101 is activated and is connected with the retina display unit 102 via a wired or wireless way. At this time, the user can, by the retina display unit 102 which is similar to a glasses-type device, sense a virtual interactive interface presented in the front, such as an icon of E-book application and a pointer on the interface.

Then, the user moves his hand(s) to move the pointer in the virtual interface onto the icon of the E-book application. The camera unit 103, integrated with the retina display unit 102, continuously collects the operating process image(s) of the user's gesture (30 frames collected per second, for example), and transmit the image(s) to the identification-interaction unit 104. The identification-interaction unit 104, by means of a series of stable redundancy algorithms, makes analysis to the image(s), finds out the user's operation intention (i.e. the interactive operation command) best matching the user's gesture, and transforms it into command data stream, and the command data stream is transmitted to the signal source 101 via a wired or wireless way. Then, the signal source 101, based on the command data stream, updates the pointer's position in the virtual interface.

Subsequently, the user makes a clicking motion which is captured by the camera unit 103 and transmitted to the identification-interaction unit 104. The identification-interaction unit 104 makes analysis to this motion, obtains the interactive operation command for opening the E-book application by the user, and transmits this interactive operation command to the signal source 101. The signal source 101 processes this interactive operation command wherein the specific processing includes: opening the E-book application, updating the display signal in real time and outputting it to the retina display unit 102. At this time, the user can find that the E-book application is opened.

If the user wants to make a page turning operation, it is necessary for the user to only wave the hand from right to left (or other gestures, as long as the gestures are in conformity with the pre-set corresponding relation(s) to the page-turning operation). The camera unit 103, integrated with the retina display unit 102, continuously collects the operating process image(s) of user's gesture (30 frames collected per second, for example), and transmits the operating process image(s) to the identification-interaction unit 104. The identification-interaction unit 104, by means of a series of stable redundancy algorithms, makes analysis to obtain a valid gesture trajectory of the user, and further obtains the user's operation intention best matching this gesture trajectory, and transforms it to command data stream, and the command data stream is transmitted to the signal source 101. The signal source 101, after receiving and processing this command data stream, makes a corresponding response, the display signal shows the process of turning to the next page of the E-book and finally shows the next page of the E-book.

Finally, the user closes the interaction interface by a pre-set gesture.

In the above procedure, it is possible to pre-set the corresponding relation(s) between the user's gesture(s) and the specific interactive operation command(s). Furthermore, such corresponding relation(s) is/are preferably editable, and thus it is easy to add a new interactive operation command, or to change the gesture corresponding to the interactive operation command based on the user's habits.

Based on the above analysis, in an embodiment of the present invention, a method for user interaction is also provided.

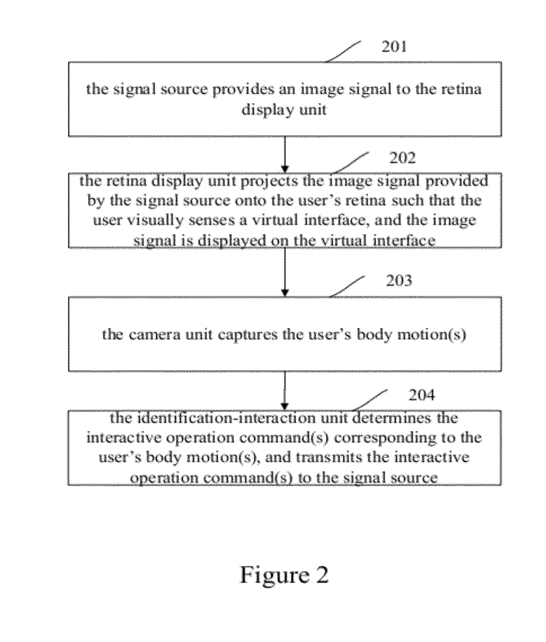

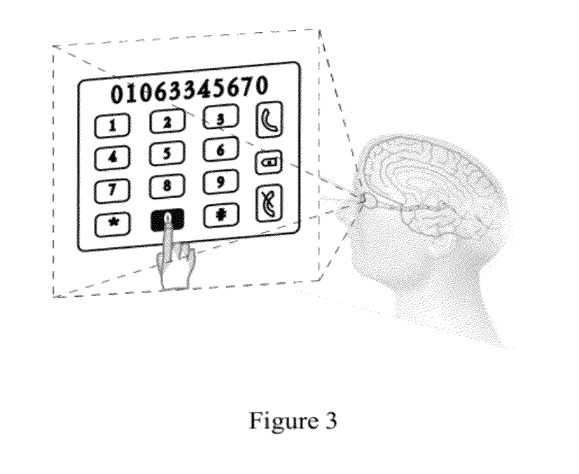

FIG. 2 is a schematic diagram illustrating the flowchart of a method for user interaction according to an embodiment of the present invention. FIG. 3 is a schematic diagram illustrating the gesture touch-controlling interaction according to an embodiment of the present invention.

As shown in FIG. 2, this method includes:

Step 201: the signal source provides an image signal to the retina display unit.

Step 202: the retina display unit projects the image signal provided by the signal source onto the user's retina such that the user visually senses a virtual interface, and the image signal is displayed on the virtual interface.

Step 203: the camera unit captures the user's body motion(s).

Step 204: the identification-interaction unit determines the interactive operation command(s) corresponding to the user's body motion(s), and transmits the interactive operation command(s) to the signal source.

This method further includes that the signal resource, after receiving the interactive operation command from the identification-interaction unit, provides the image signal, corresponding to that after execution of this interactive operation command, to the retina display unit in real time.

In an embodiment, “the camera unit captures the user's body motion(s)” includes: the camera unit captures the user's precise positioning operation and/or non-precise positioning operation on the virtual interface. In the embodiment, the precise positioning operation may include: clicking a button on the virtual interface or choosing a specific region on the virtual interface, while the non-precise positioning operation may include: hand waving from right to left, hand waving from left to right, hand waving from up to down, hand waving from down to up, or separating or converging of hands, as well as other gesture trajectory or trajectories following some specific principles.

As can be found from FIG. 3, the user can achieve a touch-controlling interaction in the virtual interface, and thus the prior physically presented keyboard or screen and other input/output devices can be omitted.

In conclusion, in embodiments of the present invention, an inventive system and an inventive method for user interaction are provided. In an embodiment of the present invention, a signal source provides an image signal to a retina display unit; the retina display unit projects the image signal provided by the signal source onto the user's retina such that the user visually senses a virtual interface, and the image signal is displayed on the virtual interface; a camera unit captures the user's body motion(s); an identification-interaction unit determines interactive operation command(s) corresponding to the user's body motion(s), and transmits the interactive operation command(s) to the signal source. As can be seen, with the embodiment of the present invention, the physically presented keyboard and touching screen are not needed, and a manner of the interaction and information acquisition between the user and a hardware device is achieved by means of a virtual interface, thus improving the user experience greatly.

Furthermore, this manner of interaction is very natural, in conformity with the interaction mode of human's basic gestures, and with a reduced study cost for users to operate devices. This manner of interaction is in conformity with the natural interaction, operation and control with the human body as well as the separation design of hardware device for processing portable information, thus a person can pay more attention to the information he/she concerns rather than the hardware device itself.

In addition, the unique display manner of the embodiments of the present invention makes itself to be less affected by environment, provides a person with a high-quality sensory experience and can protect the information privacy. With the embodiments of the present invention, by mans of a manner of retina scanning projection display, virtual information can be integrated with a real scene to provide the user with an augment reality sensory experience, based on which there can generate a lot of practical applications to improve the user experience greatly.

Moreover, the embodiments of the present invention can be applied to any device for human-machine information interaction, and have a generality to facilitate people greatly.

What is described above is only preferred embodiments of the present invention. The protection scope of the present invention, however, is not limited to the above preferred embodiments. Any modification or equivalent substitution or improvement, made within the spirit and principles of the embodiments of the present invention, will fall within the protection scope of the embodiments of the present invention.

1. A system for user interaction, comprising a signal source, a retina display unit, a camera unit and an identification-interaction unit, wherein
the signal source is configured to provide an image signal to the retina display unit;
the retina display unit is configured to project the image signal provided by the signal source onto the user's retina such that the user visually senses a virtual interface, and said image signal is displayed on said virtual interface;
the camera unit is configured to capture the user's body motion;
the identification-interaction unit is configured to determine an interactive operation command corresponding to the user's body motion and transmit said interactive operation command to the signal source.

2. The system according to claim 1, wherein the signal source is further configured to provide the image signal, corresponding to that after execution of said interactive operation command, to the retina display unit in real time.

3. The system according to claim 1, wherein the said retina display unit is a glasses-type displayer or a direct retinal projection device.

4. The system according to claim 1, wherein the said signal source is a mobile terminal, a computer or an information service platform based on cloud computing.

5. The system according to claim 1, wherein said retina display unit, camera unit and identification-interaction unit are physically integrated into a whole.

6. The system according to claim 1, wherein said identification-interaction unit and signal source are physically integrated into a whole, and said retina display unit and camera unit are physically integrated into a whole.

7. The system according to claim 1, wherein said retina display unit is configured to superimpose the virtual interface on the real environment viewing field formed by real environment light around the user.

8. The system according to claim 7, wherein
said retina display unit is further configured to display a spatial virtual pointer element corresponding to user's hand on the virtual interface and/or the real environment viewing field;
the identification-interaction unit is further configured to locate and track position and shape information of user's hand in real time based on image data of user's hand motion, and feed back the position and shape information of user's hand to the signal source; and
the signal source is further configured to output the image signal of the spatial virtual pointer element to the retina display unit in real time to achieve that a moving trajectory of the spatial virtual pointer element is in conformity with the user's hand motion on the virtual interface, according to the position and shape information of user's hand provided by the identification-interaction unit.

9. The system according to claim 1, wherein the system further comprises a voice acquisition unit, configured to acquire user's voice interactive command and transmit the voice interactive command to the identification-interaction unit; wherein
the identification-interaction unit is configured to identify user's interactive intention command by a voice identification process to the user's voice interactive command; and
the signal source is configured to provide the retina display unit in real time with the image signal corresponding to that after execution of the identified user's interactive intention command, based on the user's interactive intention command identified by the identification-interaction unit.

10. A method for user interaction comprising:
by a signal source, providing an image signal to a retina display unit;
by the retina display unit, projecting the image signal provided by the signal source onto the user's retina such that the user visually senses a virtual interface, and the image signal being displayed on the virtual interface;
by a camera unit, capturing the user's body motion;
by an identification-interaction unit, determining an interactive operation command corresponding to the user's body motion and transmitting the interactive operation command to the signal source.

11. The method according to claim 10, further comprising:
by the signal source, providing the image signal, corresponding to that after execution of the interactive operation command, to retina display unit in real time.

12. The method according to claim 10, wherein by the camera unit, capturing the user's body motion comprises:
by the camera unit, capturing the user's precise positioning operation and/or non-precise positioning operation on the virtual interface.

13. The method according to claim 12, wherein said precise positioning operation includes: clicking a button on the virtual interface or choosing a specific region on the virtual interface.

14. The method according to claim 12, wherein said non-precise positioning operation includes: hand waving from right to left, hand waving from left to right, hand waving from up to down, hand waving from down to up, or separating or converging of hands.

15. The method according to claim 12, wherein said projecting the image signal provided by the signal source onto the user's retina such that the user visually senses a virtual interface, and the image signal being displayed on the virtual interface comprises: superimposing said virtual interface on the real environment viewing field formed by the real environment light around the user.

16. The method according to claim 15, further comprising:
by the retina display unit, displaying a spatial virtual pointer element corresponding to user's hand on the virtual interface and/or the real environment viewing field;
by the identification-interaction unit, locating and tracking the position and shape information of user's hand in real time based on image data of user's hand motion, and feeding back the position and shape information of user's hand to the signal source, and
by the signal source, outputting the image signal of the spatial virtual pointer element to the retina display unit in real time to achieve that a moving trajectory of the spatial virtual pointer element is in conformity with the user's hand motion on the virtual interface, according to the position and shape information of user's hand provided by the identification-interaction unit.

17. The method according to claim 16, wherein said spatial virtual pointer element is a transparent profile line typed pointer superimposed on the user's hand.

18. The system according to claim 2, wherein said retina display unit is configured to superimpose the virtual interface on the real environment viewing field formed by real environment light around the user.

19. The system according to claim 3, wherein said retina display unit is configured to superimpose the virtual interface on the real environment viewing field formed by real environment light around the user.

20. The system according to claim 4, wherein said retina display unit is configured to superimpose the virtual interface on the real environment viewing field formed by real environment light around the user.
